(19) United States
(12) Patent Application Publication
(10) Pub. No.: US 2002/0011054 A1
(43) Pub. Date: Jan. 31, 2002

(54) Bagless canister vacuum cleaner

(76) Inventor: Billy Yung, Hong Kong (HK)

Correspondence Address: SHELDON & MAK PC, 9th Floor, 225 S. Lake Ave., Pasadena, CA, 91101, US

(21) Appl. No.: 09/922,890

(22) Filed: Aug. 6, 2001

Related U.S. Application Data
(63) Continuation-in-part of application No. 09/457,613, filed on Dec. 8, 1999, now Pat. No. 6,269,518.

(51) Int. Cl. B01D 46/00

(52) U.S. Cl. 55/467

(57) ABSTRACT

A bagless vacuum cleaner having a chasse, an air blower and a dust extraction and collection unit is provided. The dust extraction and collection unit has an easily removable inlet chamber and an easily removable outlet chamber. The inlet chamber is substantially cylindrical, and the outlet chamber is disposed concentrically within the upper portion of the inlet chamber. Duct work within the chasse conducts air from the base of the chasse and into the inlet chamber in tangential fashion, such that air swirls about the inside walls of the inlet chamber. Air within the inlet chamber is then allowed to escape from the inlet chamber into the outlet chamber via a plurality of small holes disposed in the side walls of the outlet chamber. Air within the outlet chamber is exhausted to the blower via a top wall opening in the outlet chamber. The outlet chamber contains a vertical, cylindrical filter disposed concentrically within the outlet chamber and a second, planar filter disposed across the top wall opening of the outlet chamber.

### RELATED APPLICATIONS

This application is a continuation-in-part application of U.S. patent application Ser. No. 09/457,613 filed Dec. 8, 1999. This application incorporates the entirety of U.S. patent application Ser. No. 09/457,613 by this reference.

### FIELD OF THE INVENTION

This invention relates generally to vacuum cleaners and, more particularly, to bagless vacuum cleaners.

### BACKGROUND OF THE INVENTION

Bagless vacuum cleaners have become very popular over the last several years. such vacuum cleaners. In old style cloth bag-containing vacuum cleaners, dust and dirt removal is a difficult and awkward process, frequently requiring the user to extend his or her hand into the cloth bag to physically disengage dust clumps. Vacuum cleaners using disposable liner bags minimize the problems associated with cloth bags, but the use of such vacuum cleaners requires the continuous replenishment and installation of disposable liner bags. (Also, owners of older model disposable liner bag-containing vacuum cleaners often find it difficult to locate a source of properly sized replacement liner bags.)

Contrary to these problems associated with bag-containing vacuum cleaners, dirt and dust vacuumed up using bagless vacuum cleaners is conveniently deposited into an easily removable permanent container, from which dust and dirt can be disposed of without the effort associated with cloth bag-containing vacuum cleaners and without having to continually purchase and reinstall disposable liner bags.

Bagless vacuum cleaners of the prior art, however, have not been fully satisfactory. Most bagless vacuum cleaners have not demonstrated the ability to fully disengage dust and dirt from the vacuum air stream. Those prior art bagless vacuum cleaners which have been reasonably successful in disengaging dust and dirt from the vacuum air stream have required a high degree of mechanical complexity. Such mechanical complexity has tended to make those prior art bagless vacuum cleaners unduly expensive to manufacture and maintain.

Accordingly, there is a need for a bagless vacuum cleaner which avoids these problems with the prior art.

### SUMMARY

The present invention is essentially the same invention as that which is set forth in U.S. patent application Ser. No. 09/457,613, except that the chasse and housing unit is configured in a canister-style as illustrated in the drawings.

### DRAWINGS

These features, aspects and advantages of the present invention will become better understood with regard to the following description, appended claims and accompanying figures where:

FIG. 1 is a perspective view of a vacuum cleaner having features of the invention;

FIG. 2 is a top view of the vacuum cleaner illustrated in FIG. 1;

FIG. 3 is a bottom view of the vacuum cleaner illustrated in FIG. 1;

FIG. 4 is a top view of the vacuum cleaner illustrated in FIG. 1;

FIG. 5 is a first side view of the vacuum cleaner illustrated in FIG. 1;

FIG. 6 is a second side view of the vacuum cleaner illustrated in FIG. 1;

FIG. 7 is front view of the vacuum cleaner illustrated in FIG. 1; and

FIG. 8 is a cross sectional diagram showing the internal components of the vacuum cleaner illustrated in FIG. 1.

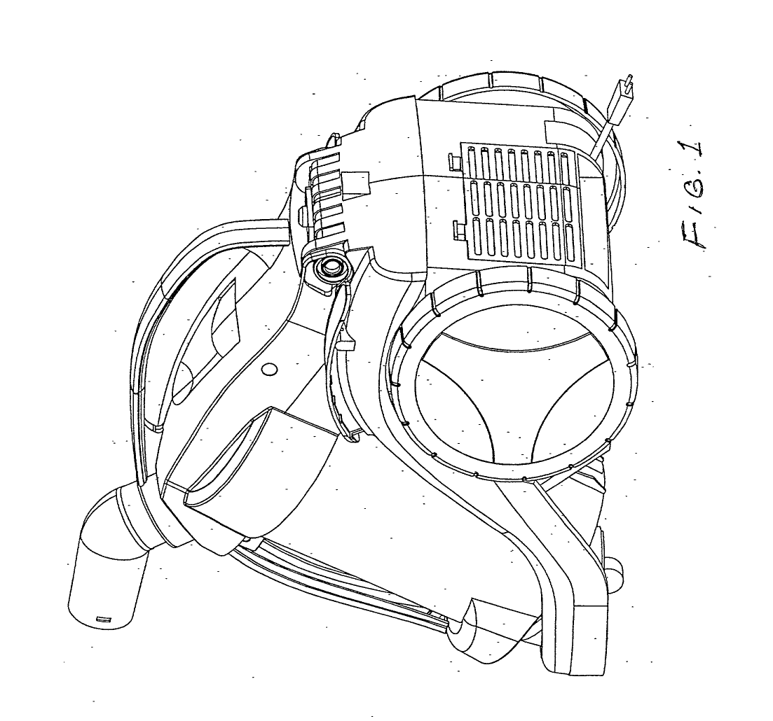

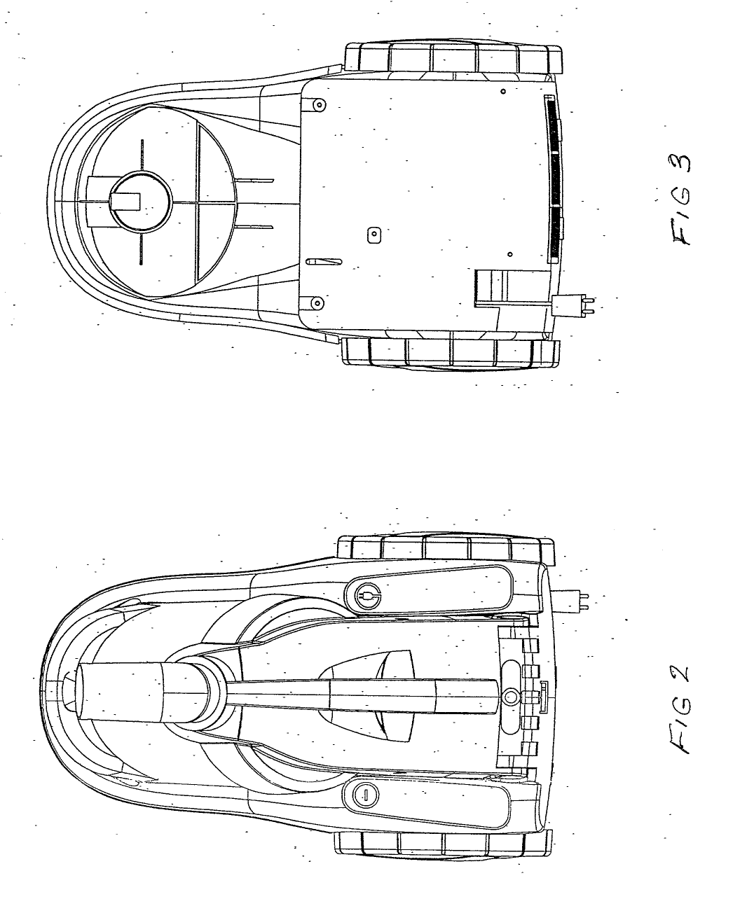

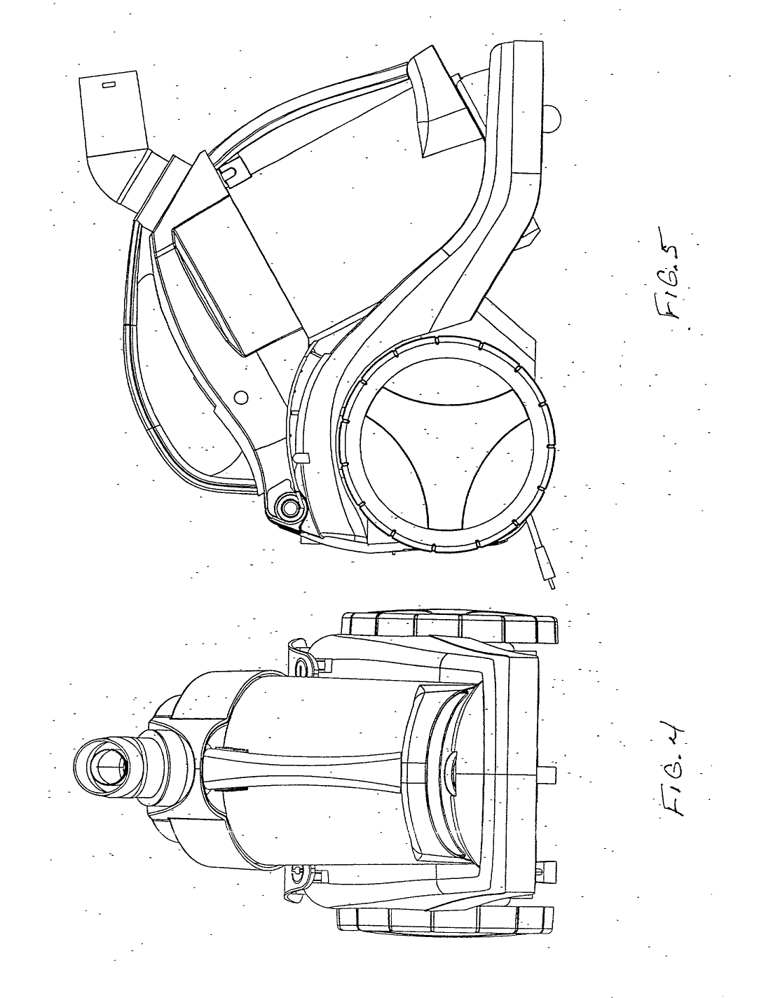

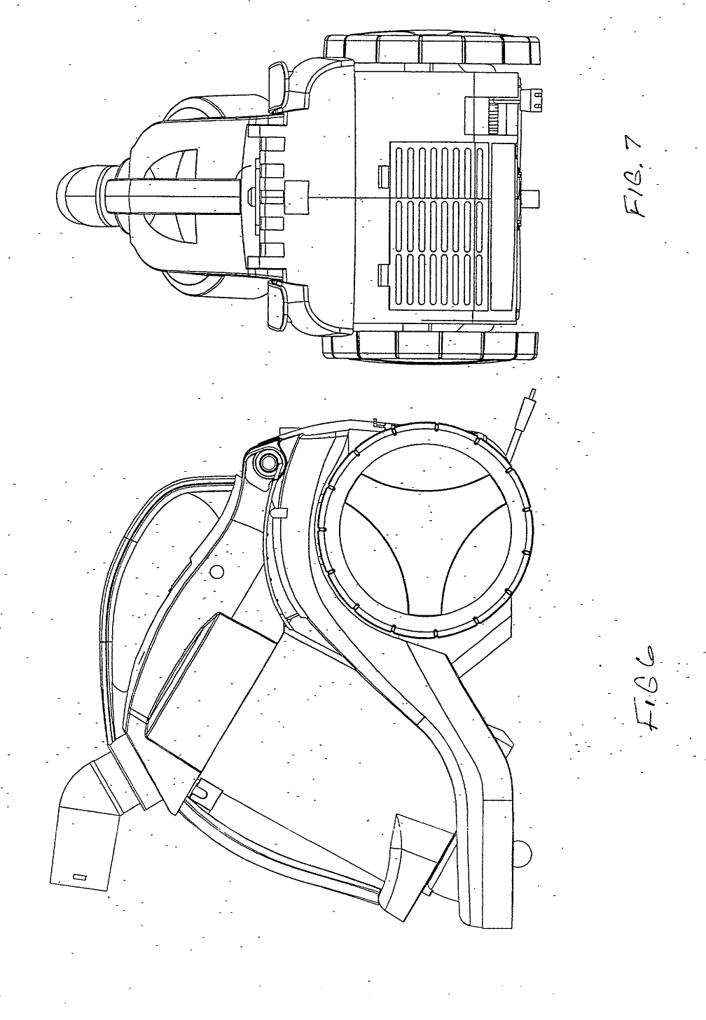

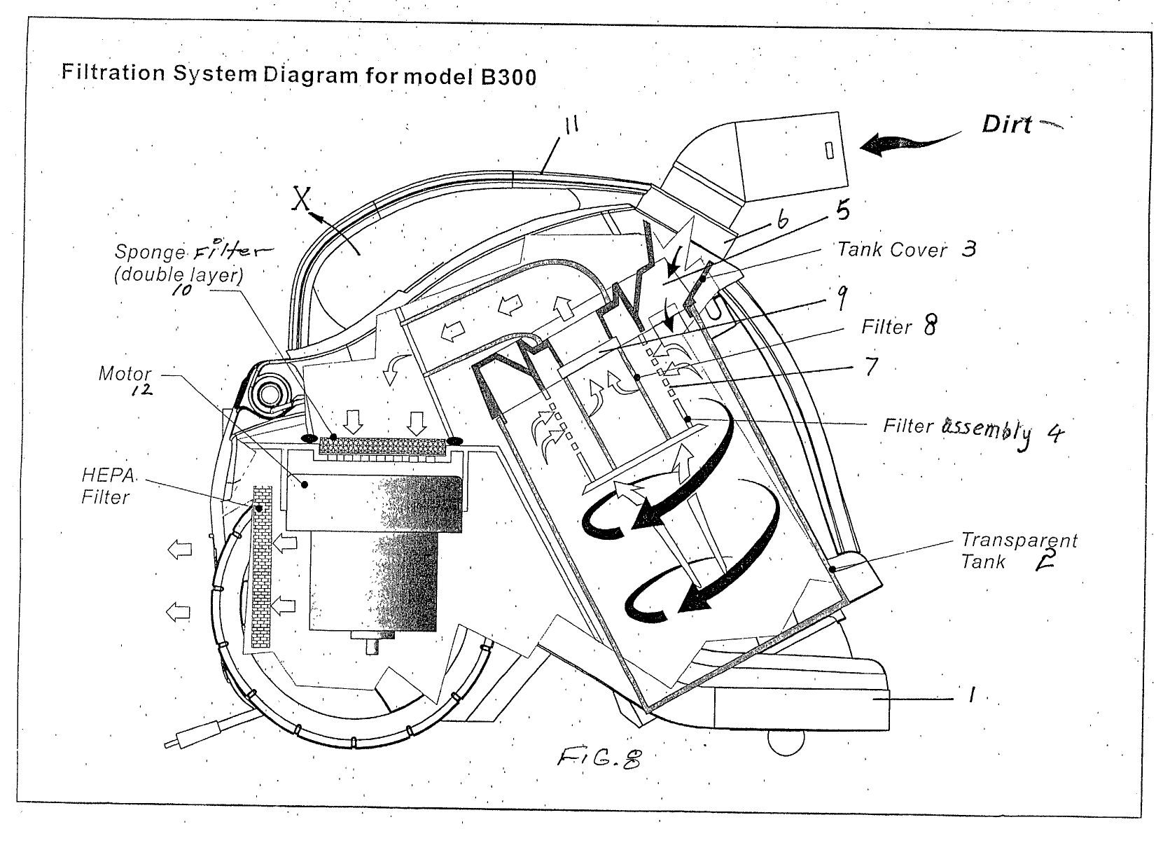

### DETAILED DESCRIPTION

The following discussion describes in detail one embodiment of the invention and several variations of that embodiment. This discussion should not be construed, however, as limiting the invention to those particular embodiments. Practitioners skilled in the art will recognize numerous other embodiments as well.

The detailed description of the invention is essentially the same as that which is disclosed in U.S. patent application Ser. No. 09/457,613 the contents of which are incorporated herein, in their entireties, by this reference. The differences between that which is disclosed in U.S. patent application Ser. No. 09/457,613 and the present invention is that the internal components disclosed in the '613 application are housed in the present invention in a chasse and housing unit having the shape and the configuration as shown in the drawings.

The invention has been found to provide a vacuum cleaner with all the conveniences of prior art vacuum cleaners, but with increased dust removal efficiency and without excessive mechanical complexity and resulting expense of manufacture.

Having thus described the invention, it should be apparent that numerous structural modifications and adaptations may be resorted to without departing from the scope and fair meaning of the instant invention as set forth hereinabove and as described hereinbelow by the claims.

What is claimed is:

1. A vacuum cleaner comprising:
(a) a chasse having a base unit and a housing unit, the base unit having an air inlet and roller means for moving the vacuum cleaner across a flat surface;
(b) an air blower disposed within the chasse;
(c) a dust extraction and collection unit disposed within the housing unit, the dust extraction and collection unit comprising:
(i) an enclosed inlet chamber, the inlet chamber being substantially cylindrical in shape with an internal diameter between about 130 mm and about 200 mm, the inlet chamber comprising a bottom wall, generally vertical sidewalls, an upper section, a lower section and an air inlet opening, the sidewalls having an interior height between about 200 mm and about 250 mm, the upper section of the inlet chamber having an air inlet opening through the sidewalls; and
(ii) an enclosed outlet chamber disposed concentrically within the upper section of the inlet chamber, the outlet chamber having a bottom wall, a top wall and generally vertical sidewalls, the top wall having a top wall opening, the sidewalls having an interior height between about 50 mm and about 100 mm, the sidewalls also having between about 1000 and about 1500 inlet apertures, each inlet aperture defining an area between about 3 mm² and about 30 mm², the inlet apertures being disposed in a band around the sidewalls of the outlet chamber, the band having a width between about 20 mm and about 50 mm and a median line disposed between about 30 mm and about 100 mm above the bottom wall, the outlet chamber further having an upper section, a lower section and a circular exterior perimeter edge member disposed around the sidewalls in the lower section of the outlet chamber, the exterior edge member having a diameter between about 10 mm and about 60 mm less than the internal diameter of the inlet chamber; and
(d) duct work for serially connecting in fluid communication the air inlet in the base unit, the inlet chamber, the outlet chamber and the air blower;
wherein the components of the vacuum cleaner are as illustrated in the drawings.
